(19) United States
(12) Patent Application Publication
(10) Pub. No.: US 2024/0124235 A1
(43) Pub. Date: Apr. 18, 2024

(54) SMART GONDOLA SYSTEM

(71) Applicant: AiFi Corp, Santa Clara, CA (US)

(72) Inventor: Carlos Ruiz Dominguez, Santa Clara, CA (US)

(73) Assignee: AiFi Corp, Santa Clara, CA (US)

(21) Appl. No.: 17/966,838

(22) Filed: Oct. 15, 2022

(51) Int. Cl. B65G 1/137; G06Q 10/08; G06Q 30/06

(52) U.S. Cl. CPC B65G 1/1375; G06Q 10/087; G06Q 30/0639

(57) ABSTRACT

The present invention describes a gondola system for monitoring items coupled with support utilities. The system is configured to detect item changes caused by customer actions and optimize the camera system and computing resources of a remote server. The system also is configured to sense certain visual indicators with customer actions.

### BACKGROUND OF THE INVENTION

This application relates to systems, methods, devices, and other techniques for a smart gondola of monitoring items coupled with support utilities. The system is configured to detect items addition, removal or change caused by customer actions and optimizes the computing resources of a remote server. The system is also configured to sense items that are removed, added, or misplaced automatically. The system also can coordinate the gondola, camera systems, and LED lights to optimize the shopping experience. The system also can utilize mirrors to widen the field of view of a camera system.

Retail stores frequently display products on shelves for easy accessibility by customers. A gondola may be attached to a wall, a stand, or any other surface. Typically, one or more products or items are placed on a gondola. A gondola sometimes includes a label or other signage indicating the name or type of items placed on a gondola. Customers can frequently remove, add or change items on a gondola.

Therefore, it is desirable to have a gondola system that is configured to detect actions caused by customer actions and optimize the camera system and computing resources of a remote server. Also, it is beneficial to have the system sense items that are removed, added or misplaced automatically. Also, it is beneficial to have LED lights blinking to guide customers based on their previous choices and some predetermined patterns.

### SUMMARY OF THE INVENTION

This application relates to systems, methods, devices, and other techniques for a smart gondola of monitoring items coupled with support utilities. The system is configured to detect items addition, removal or change caused by customer actions and optimizes the computing resources of a remote server. The system is also configured to sense items that are removed, added, or misplaced automatically. The system also can coordinate the gondola, camera systems, and LED lights to optimize the shopping experience. The system also can utilize mirrors to widen and deepen the field of view of the camera system.

In some embodiments, the invention is related to a gondola system in a retail store, comprising: at least one gondola, wherein the at least one gondola is comprised of one or more shelves, wherein a set of items are attached to the one or more shelves, wherein a set of weight sensors are placed on each corner of the at least one gondola, wherein the set of weight sensors are configured to measure weight data, wherein the set of weight sensors are placed at the each corner of the at least one gondola, wherein the set of weight sensors comprises at least two weight sensors; a data processing device coupled to the set of weight sensors, wherein the data processing device is configured to calculate weight and change in weight by combining the weight data from the each corner of the at least one gondola, wherein the data processing device is configured to determine location of an item removed or placed by calculating the location based on changes of weight data at the each corner of the at least one gondola and some input from a camera system that is coupled to the data processing device; a set of indicators coupled to the gondola system, wherein each of the set of indicators is placed under each item coupled to the gondola system, wherein the each of the set of indicators is configured to blink when the each item above the each of the set of indicators is removed; and a remote server coupled to the data processing device and the set of cameras via a network, wherein the remote server is configured to receive information of the location of the item removed or placed from the data processing device.

In some embodiments, the invention is related to a gondola system in a retail store, comprising: at least one gondola, wherein the at least one gondola is comprised of one or more shelves, wherein a set of items are attached to the one or more shelves, wherein a set of weight sensors are placed on each corner of the at least one gondola, wherein the set of weight sensors are configured to measure weight data placed at the each corner of the at least one gondola; a data processing device coupled to the set of weight sensors, wherein the data processing device is configured to calculate weight and change in weight by combining the weight data from the each corner of the at least one gondola, wherein the data processing device is configured to determine location of an item removed or placed by calculating the location based on changes of weight data at the each corner of the at least one gondola and some input from at least three cameras that are coupled to the data processing device in the retail store, wherein at least one of the at least three cameras is configured to detect infrared; a remote server coupled to the data processing device and the set of cameras via a network, wherein the remote server is configured to receive information of the location of the item removed or placed from the data processing device; and a set of visual indicators coupled to the at least one gondola, wherein the set of visual indicators are coupled to blink to identify the geo-location of the at least one gondola, wherein the set of visual indicators are configured to blink pre-determined patterns to convey digital data to the remote server via the set of cameras, wherein one type of the digital data is unique ID of the at least one gondola, wherein the unique ID is related to the physical location of the at least one gondola, wherein the set of visual indicators are configured to direct a shopper to a specific item the shopper has purchased before, or an item on the shopper's request, or an item that has a special discount.

In some embodiments, the gondola system has a network that is connected by Ethernet.

In some embodiments, the set of weight sensors, the set of cameras, and the set of cameras are using power over Ethernet.

These and other aspects, their implementations, and other features are described in detail in the drawings, the description, and the claims.

### BRIEF DESCRIPTION OF THE DRAWINGS

FIG. 1 shows an example diagram of a gondola system for autonomously monitoring items.

FIG. 2 shows another example diagram of a gondola system for autonomously monitoring items.

### DETAILED DESCRIPTION OF THE INVENTION

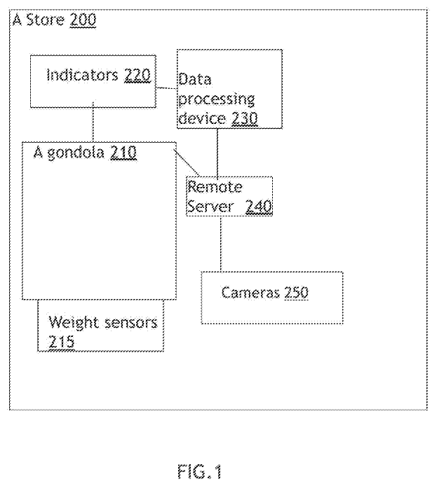

FIG. 1 shows an example diagram of a gondola system for autonomously monitoring items.

In some implementations, the system comprises a gondola 110. In some embodiments, the gondola 110 can be represented as a board having a regular pattern of holes for inserting shelves, used chiefly for display of items or products. In some embodiments, a gondola can be any means to attach multiple shelves with items for sale.

In some embodiments, the system comprises a gondola 110. In some embodiments, a gondola 110 can be any shape of solid surface that items or products can be put on. In some embodiments, multiple shelves are attached to the gondola 110. In some embodiments, various computer chips, various sensors, different circuitry and other components may attach to the gondola 110.

In some embodiments, the weight sensor 115 is coupled to the gondola 110. In some embodiments, the weight sensors comprise different sensors, such as motion detecting sensors, force sensors, load sensors, weight sensors, light sensors and other sensors. In some embodiments, the weight sensors comprise processors. In some embodiments, the weight sensors comprise communication units. In some embodiments, the communication units are wireless communication units. In some embodiments, the communications units are wired communication units. In some embodiments, weight sensors are coupled to the remote server 130 by a device processing device 140 via a communication unit or units.

In some embodiments, the invention is related to a gondola system 110 in a retail store 100, comprising: at least one gondola 110, wherein the at least one gondola 110 is comprised of one or more shelves, wherein a set of items are attached to the one or more shelves, wherein a set of weight sensors 115 are placed on each corner of the at least one gondola, wherein the set of weight sensors 115 are configured to measure weight data, wherein the set of weight sensors are placed at the each corner of the at least one gondola, wherein the set of weight sensors comprises at least two weight sensors; a data processing device 140 coupled to the set of weight sensors, wherein the data processing device is configured to calculate weight and change in weight by combining the weight data from the each corner of the at least one gondola, wherein the data processing device 140 is configured to determine location of an item removed or placed by calculating the location based on changes of weight data at the each corner of the at least one gondola and some input from a camera system that is coupled to the data processing device; a set of indicators 120 coupled to the gondola system, wherein each of the set of indicators 120 is placed under each item coupled to the gondola system, wherein the each of the set of indicators 120 is configured to blink when the each item above the each of the set of indicators is removed; and a remote server 130 coupled to the data processing device and the set of cameras via a network, wherein the remote server is configured to receive information of the location of the item removed or placed from the data processing device.

In some embodiments, the gondola system has the network that is connected by Ethernet.

In some embodiments, the set of weight sensors, the set of cameras and the set of cameras are using power over Ethernet.

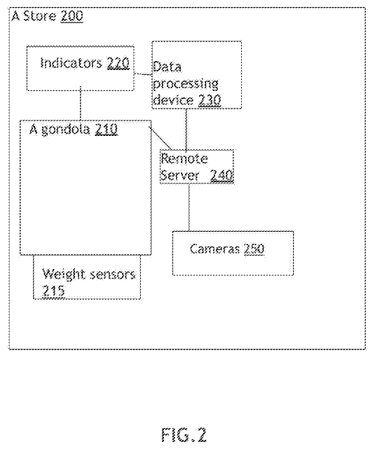

FIG. 2 shows another example diagram of a gondola system for autonomously monitoring items.

In some embodiments, the invention is related to a gondola system comprising: at least one gondola 210 in a store 200, wherein the at least one gondola 210 is comprised of one or more shelves, wherein a set of items are attached to the one or more shelves, wherein a set of weight sensors 215 are placed on each corner of the at least one gondola 210, wherein the set of weight sensors 215 are configured to measure weight data placed at the each corner of the at least one gondola 210;
a data processing device coupled to the set of weight sensors 215, wherein the data processing device 230 is configured to calculate weight and change in weight by combining the weight data from the each corner of the at least one gondola 210, wherein the data processing device 230 is configured to determine location of an item removed or placed by calculating the location based on changes of weight data at the each corner of the at least one gondola 210 and some input from at least three cameras 250 that are coupled to the data processing device 230 in the retail store, wherein at least one of the at least three cameras is configured to detect infrared; a remote server 240 coupled to the data processing device 230 and the set of cameras 250 via a network, wherein the remote server is configured to receive information of the location of the item removed or placed from the data processing device; and a set of visual indicators 220 coupled to the at least one gondola 210, wherein the set of visual indicators 220 are coupled to blink to identify the geo-location of the at least one gondola 210, wherein the set of visual indicators 220 are configured to blink pre-determined patterns to convey digital data to the remote server via the set of cameras 250, wherein one type of the digital data is the unique ID of the at least one gondola 210, wherein the unique ID is related to the physical location of the at least one gondola 210, wherein the set of visual indicators 220 are configured to direct a shopper to a specific item the shopper has purchased before, or an item on the shopper's request, or an item that has a special discount.

In some embodiments, the gondola system has a network that is connected by Ethernet.

In some embodiments, the set of weight sensors, the set of cameras and the set of cameras are using power over Ethernet.

1. A gondola system in a retail store, comprising:
at least one gondola, wherein the at least one gondola is comprised of one or more shelves, wherein a set of items are attached to the one or more shelves, wherein a set of weight sensors are placed on each corner of the at least one gondola, wherein the set of weight sensors are configured to measure weight data, wherein the set of weight sensors are placed at the each corner of the at least one gondola, wherein the set of weight sensors comprises at least two weight sensors;
a data processing device coupled to the set of weight sensors, wherein the data processing device is configured to calculate weight and change in weight by combining the weight data from the each corner of the at least one gondola, wherein the data processing device is configured to determine location of an item removed or placed by calculating the location based on changes of weight data at the each corner of the at least one gondola and some input from a camera system that is coupled to the data processing device;
a set of indicators coupled to the gondola system, wherein each of the set of indicators is placed under each item coupled to the gondola system, wherein the each of the set of indicators is configured to blink when the each item above the each of the set of indicators is removed; and
a remote server coupled to the data processing device and the set of cameras via a network, wherein the remote server is configured to receive information of the location of the item removed or placed from the data processing device.

2. The gondola system of claim 1, wherein the network is connected by Ethernet.

3. The gondola system of claim 2, wherein the set of weight sensors and the camera system are using power over Ethernet.

4. A gondola system in a retail store, comprising:
at least one gondola, wherein the at least one gondola is comprised of one or more shelves, wherein a set of items are attached to the one or more shelves, wherein a set of weight sensors are placed on each corner of the at least one gondola, wherein the set of weight sensors are configured to measure weight data placed at the each corner of the at least one gondola;
a data processing device coupled to the set of weight sensors, wherein the data processing device is configured to calculate weight and change in weight by combining the weight data from the each corner of the at least one gondola, wherein the data processing device is configured to determine location of an item removed or placed by calculating the location based on changes of weight data at the each corner of the at least one gondola and some input from at least three cameras that are coupled to the data processing device in the retail store, wherein at least one of the at least three cameras is configured to detect infrared;
a remote server coupled to the data processing device and the set of cameras via a network, wherein the remote server is configured to receive information of the location of the item removed or placed from the data processing device; and
a set of visual indicators coupled to the at least one gondola, wherein the set of visual indicators are coupled to blink to identify the geo-location of the at least one gondola, wherein the set of visual indicators are configured to blink pre-determined patterns to convey digital data to the remote server via the set of cameras, wherein one type of the digital data is unique ID of the at least one gondola, wherein the unique ID is related to the physical location of the at least one gondola, wherein the set of visual indicators are configured to direct a shopper to a specific item the shopper has purchased before, or an item on the shopper's request, or an item that has a special discount.

5. The gondola system of claim 4, wherein the network is connected by Ethernet.

6. The gondola system of claim 5, wherein the set of weight sensors and the at least three cameras are using power over Ethernet.
